(19) United States
(12) Patent Application Publication
(10) Pub. No.: US 2022/0166876 A1
(43) Pub. Date: May 26, 2022

(54) Social Networking Service for Sharing Recordings of Phone Calls

(71) Applicant: Assaf Bivas, Karkur Pardes Hana (IL)

(72) Inventor: Assaf Bivas, Karkur Pardes Hana (IL)

(21) Appl. No.: 17/665,609

(22) Filed: Feb. 7, 2022

Related U.S. Application Data
(63) Continuation-in-part of application No. 16/459,617, filed on Jul. 2, 2019.

(51) Int. Cl. H04M 3/42; G06F 16/951; G06F 16/9538; G06F 16/958

(52) U.S. Cl. CPC H04M 3/42221; G06F 16/958; G06F 16/9538; G06F 16/951

(57) ABSTRACT

A method and system for a social networking service for sharing recording of phone calls performed by a processing device running on an internet device. The method enables a user of the internet device to open an account and to be identified by a user account, enables the user to conduct the phone call with a participant by the phone call service, enables the recording of the phone call by a recording system, enables the sending to the participant a digital notification for asking permission to upload the recording to the account of the user, enables the participant to send the permission as a digital file that is stored and tagged into the recording or the processing device, and enables the user to tag the recording by hash-tag.

### RELATED APPLICATION/S

This application is a Continuation in Part of U.S. patent application Ser. No. 16/459617 filed Jul. 2, 2019.

### TECHNICAL FIELD The present invention in some embodiments thereof relates to a method for a social networking service for sharing recordings of phone calls.

### BACKGROUND ART

Pycock (U.S. Patent Publication No. 2016/0063276) appears to disclose, “A method performed in relation to a private conversation conducted over a network between a selected group of two or more users, each of the group of users participating in the conversation from a respective instance of a communication client application run on a respective user device. The private conversation comprises one or more content items, each of these content items being shared by a respective source user of the group with one or more other users of the group internally within the private conversation. The method comprises associating a respective permissions model with each respective one of the content items, the permission model being configured to act on the client application to control permission for the one or more other users to use the respective content item outside of said conversation.”

Othmer (U.S. Patent Publication No. 2007/0211876) appears to disclose, “Wireless telecommunications systems, methods and devices for processing voice data in connection with a wireless telecommunications system that includes a wireless remote device and a wireless recording device that are configured for communication with a network server. Methods include obtaining varying levels of consent from users of recording devices and/or remote devices. The recording device can access recording rules that cross-reference the consent information to determine whether to record the conversation if the recording statute indicates that such recording is lawful.

Tarbox (U.S. Patent Publication No. 2014/0297745) appears to disclose, “Disclosed are methods and apparatus for processing social media posts. The methods may include certain multimedia content being identified as multimedia content for which social media posts relating to a broadcast of that multimedia content are to be stored. Using this identifying information, one or more filtering criteria may be provided for use by a filtering module. The filtering module may receive (e.g., from a social networking service) a stream of social media posts, filter the received stream to extract social media posts that relate to the broadcast of the certain multimedia content, and store the extracted social media posts. Alternatively, a storage module may store the stream of social media posts, and a filtering module may filter the stored social media posts to identify social media posts that relate to the broadcast of the certain multimedia content.”

### SUMMARY OF THE INVENTION

According to an aspect of some embodiments of the invention, there is provided a system for a social networking web platform for sharing recorded phone calls of a plurality of users, including: a plurality of profiles; wherein each of the plurality of profiles is associated with a respective user of the plurality of users and includes a plurality of followers associated with the respective user; a plurality of phone call recordings associated with each respective user of the plurality of users, each of the plurality of phone calls recordings of a phone call initiated by the respective user; an index categorizing the plurality of phone call recordings; a phone calling application, a database storing the plurality of phone call recordings, and the index; a web platform integrating the phone calling application and the database configured for: publishing the database for browsing over a public network, initiating by a particular user of the plurality of users a new phone call on the phone calling application with a participant; recording the new phone call to a new phone call recording; storing the new phone call recording on the database and, associating the new the particular user, receiving a new permission from the participant; for publishing the new phone call recording, adding to the index characterizing the new phone call recordings; sending a notification of the new phone call to each follower associated with the particular user.

According to some embodiments of the invention, the publishing of each plurality phone call recordings associated with a particular user is in accordance with the profile of the particular user.

According to some embodiments of the invention, the publishing of each plurality phone call recording is in accordance with a permission of user associated with the phone call recording.

According to some embodiments of the invention, the web platform is further configured for sending digital notification requesting the permission from the participant.

According to an aspect of some embodiments of the invention, there is provided a system for a social networking web platform for sharing recorded phone calls of a plurality of users, including: a plurality of profiles; wherein each of the plurality of profiles is associated with a user of the plurality of users; a plurality of followers associated with each of the plurality of users; a plurality of phone call recordings associated with each respective user of the plurality of users, each of the plurality of phone calls initiated by the respective user; an index categorizing the plurality of phone call recordings; a phone calling application, a database storing the plurality of phone call recordings, and the index; web platform integrating the phone calling application and the database configured for: posting each recording of the plurality of phone call recordings to the followers of the user associated with the recording, initiating by a particular user of the plurality of users a new phone call on the phone calling application with a participant; recording the new phone call to a new phone call recording; storing the new phone call recording on the database and, associating the new the particular user, receiving a new permission from the participant; for publishing the new phone call recording, adding to the index characterizing the new phone call recordings.

According to some embodiments of the invention, the web platform is further configured for posting the index.

According to some embodiments of the invention, the web platform is further configured for sending digital notification requesting the permission from the participant.

According to some embodiments of the invention, the web platform is further configured for sending the digital notification via a message on a social network.

According to some embodiments of the invention, the web platform is further configured for sending the digital notification before the new phone call.

According to some embodiments of the invention, the web platform is further configured for sending the digital notification after the new phone call.

According to some embodiments of the invention, the phone call recordings are shared with other users on a social network.

According to an aspect of some embodiments of the invention, there is provided a system for sharing recorded phone calls including: a phone calling application; a database storing a plurality of recordings of phone conversations of a user, a hashtag defining a respective permission for publishing the recording each of the plurality of recordings and an index categorizing each of the plurality of recordings; and a web platform integrating the phone calling system and the database configured for initiating a new phone conversation on the phone calling application to a participant; recording the new phone conversation to a new recorded phone conversation; storing the new recorded conversation on the database; receiving a new permission for publishing the new recorded conversation from the participant; adding a new hash tag to the index characterizing the new recorded conversation; posting each of plurality of recorded conversations according to its respective permission and the new recorded conversation according to the new permission onto a social network.

According to some embodiments of the invention, the web platform is further configured for posting the index onto the social network.

According to some embodiments of the invention, the web platform is further configured for sending digital notification requesting the permission from the participant.

According to some embodiments of the invention, the web platform is further configured for sending the digital notification via a message on a social network.

According to some embodiments of the invention, the web platform is further configured for sending the digital notification before the phone conversation.

According to some embodiments of the invention, the web platform is further configured for sending the digital notification after the phone conversation.

According to some embodiments of the invention, the phone conversation recordings are shared with other users on the social network.

According to an aspect of some embodiments of the invention, there is provided a method of sharing of a recorded phone conversation including: facilitating by a web platform initiation of a phone call by a user to a participant; recording by the web platform of a recorded conversation from the phone call; saving by the web platform of the recorded conversation on a database associated to the user; receiving by the web platform a permission from the participant for sharing the recorded conversation; saving the permission as a hash tag in the database; and posting by the web platform of the recorded conversation on a social network in response to a request from the user and in accordance with the permission.

According to some embodiments of the invention, the method further includes receiving the permission via a message on a social network.

According to some embodiments of the invention, the receiving the permission is before the phone call.

According to some embodiments of the invention, the receiving the permission is after the phone call.

According to some embodiments of the invention, the method further includes indexing the recorded conversation into categories in the database.

According to some embodiments of the invention, the method further includes browsing the database on the social network.

According to some embodiments of the invention, the method further includes searching the database on the social network.

According to some embodiments of the invention, the method further includes listening to the recorded conversation on a social network.

According to an aspect of some embodiments of the invention, there is provided a method for a social networking service for sharing a recording of a phone call performed by a processing device running on an interact device, including: (a) enabling a user of the internet device to open an account and to be identified by a user account; (b) enabling the user to conduct the phone call with a participant by a phone call service; (c) recording the phone call by a recording system; (d) sending to the participant of the phone call a digital notification for asking permission from the participant to the user to upload the recording of the phone call to the account of the user; (e) enabling the participant to send the permission as a digital file that is stored and tagged with connection to the recording, the processing device of the internet device of the user or the processing device in a server; and (f) enabling the user to tag the recording by hashtag.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1A is a block diagram that illustrates two internet devices (20) of a user (20A) and of a participant (20B), each of them includes a processing device (10), and a server (100) with a processing device (30) in accordance with an embodiment of the current invention.;

FIG. 1B is a block diagram that illustrates a phone call recording system in accordance with an embodiment of the current invention.;

FIG. 2 is a flow chart illustrating an embodiment of the current invention.;

FIG. 3 is a schematic diagram illustrating an embodiment of the current invention.

FIG. 4 is a schematic diagram illustrating an embodiment of the current invention.

FIG. 5 is a block diagram illustration of a system for publishing phone calls in accordance with an aspect of the current invention.

FIG. 6 is a flow chart illustration of a method for publishing phone calls in accordance with an aspect of the current invention.

FIG. 7 is a flow chart illustration of a method for publishing phone calls in accordance with an aspect of the current invention.

FIG. 8 is a block diagram illustration of a system for publishing phone calls in accordance with an aspect of the current invention.

### DESCRIPTION OF SPECIFIC EMBODIMENTS OF THE INVENTION

### Overview

The present invention, in some embodiments thereof, provides a method that may include a web platform that serves as social media and/or using an external program and/or multiple programs for executing recordings, and/or receiving the consent of the participants of these phone calls, and/or uploading and/or tagging and/or indexing recordings.

In many cases, a person may want to share with others recordings of his phone calls and to enable them to listen to these recordings. In the same way many people may be interested in listening to recordings of phone calls of other people. The interest in sharing or listening to recordings of phone calls of others can be a result of mere snooping or professional or personal reasons.

For example, a patent lawyer conducts many phone calls with his clients in which be provides general explanations about patent laws and practices, such as, why it is important to register a patent, what is the difference between a patent application and a provisional application, how to decide whether an invention in non-obvious, and many other professional interesting topics. If this patent lawyer will have the recordings of his phone calls, then be may upload them to an online database, when be has the consent of the other party of that talk, and enable other clients or potential clients to listen to these recordings for getting useful information.

Another example, a person that records his phone calls with his girlfriend or wife in which they discuss all their private matters and enables other people to listen to these recordings for getting nosy satisfaction. These two examples are at the edges, snooping and a desire to receive important professional knowledge, and between them there is a broad spectrum of interests. Making such recordings of phone calls and uploading them to a social media service requires methods that may be designed to overcome technical and legal issues.

An objective of some embodiments of the present invention may be to provide a method performed by a processing device (10) that is designed to enable a user of internet device (20) to create a user account, and/or to record his phone calls with other people, and/or to send a notification to the participants of the phone calls for receiving from them a permission to maintain the recordings and/or to upload them to his account. The method subject matter of the present invention may include a social networking service of sharing recordings of phone calls. The term “internet device” (20) in the present patent application and in the claims refers to any kind of device which is designed to have internet connection, such as smartphones, computers, tablets and the like.

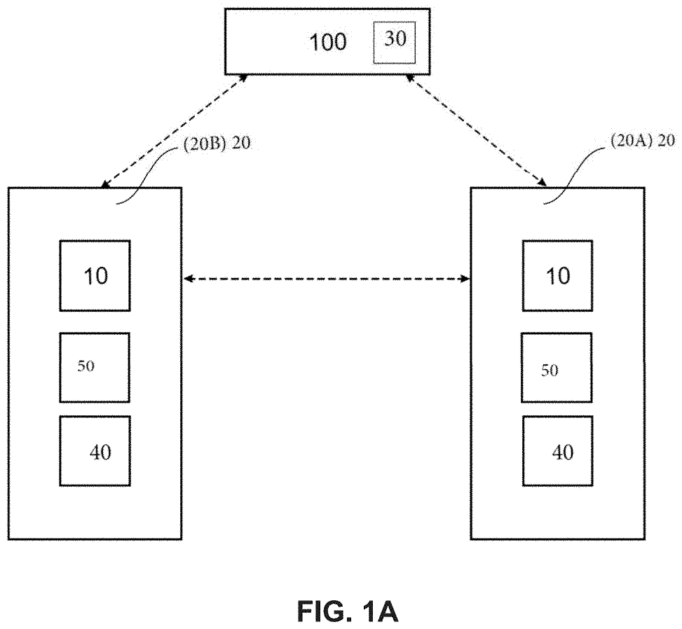

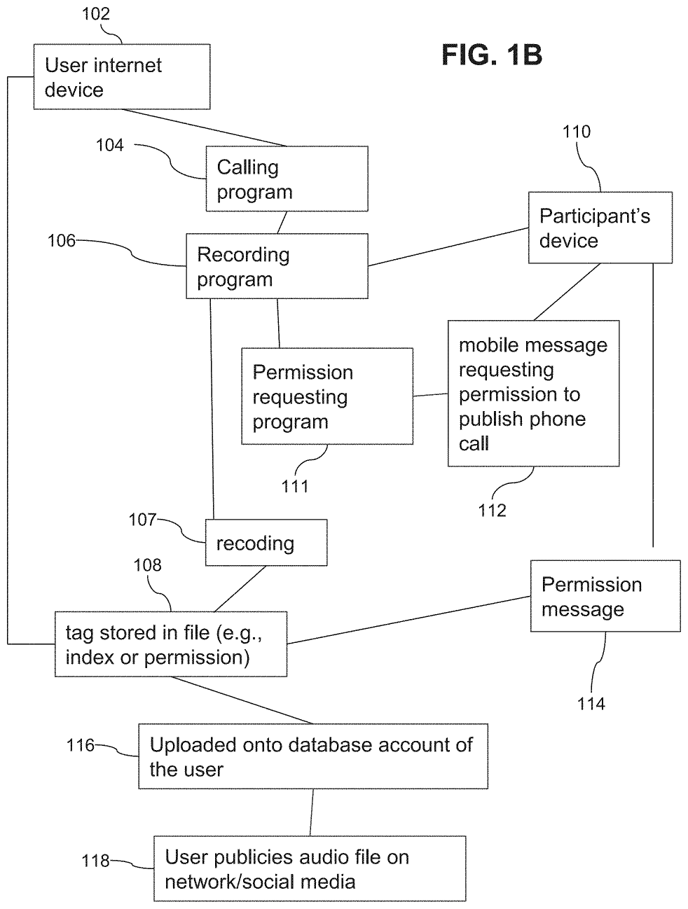

FIG. 1B is a block diagram that illustrates a phone call recording system in accordance with an embodiment of the current invention.;

There may be situations in which a user may wish to record his phone conversations and/or efficiently provide access to some or all of the recorded phone conversations to various other users. For example, other users may include other participants who were in the phone conversation and/or other users that may receive benefit from the recordings and/or may take interest in the recordings. A user may wish to allow other users to listen and/or copy and/or edit recorded conversations.

An embodiment of the current invention may include a system for recording phone conversations and/or managing them in a database and/or in a social media program and/or sharing recorded phone conversations and/or other audio files. For example, a user may wish to manage and/or share with others his various audio messages (e.g., WhatsApp) and/or recordings and/or may wish to mark messages with a description of their topic and/or importance.

An embodiment of the current invention may include its own application for calling and/or recording and/or sharing. Alternatively or additionally an embodiment may include a method for using external programs and/or social media platforms for calling and/or recording and/or organizing and/or sharing files. From here on the term a phone conversation and/or phone call etc. means any audio file.

### Exemplary Embodiments

FIG. 1A is a block diagram that illustrates two internet devices (20) of a user (20A) and of a participant (20B), each of them includes a processing device (10), and a server (100) with a processing device (30).

A web platform such as a computer program or a mobile application may be used as a framework for the overall operation and use of the method and for the sake of fluency, we will use the terms “web platform” and “method” hereinafter in this connection and as having in general the same meaning. A user of an internet device (20) may download the web platform which is performed by the processing device (10) and/or of the internet device (20), and/or may be performed by a processing device (30) in a server (100).

The method optionally includes a phone call service (40). The phone call service may include for example a VoIP service that may be an independent VoIP service and/or may employ the existing VoIP services such as Telegram™, WhatsApp™, Messenger™ and the like. The phone call service may employ the cellular network service. The method enables the user to conduct a phone call over the phone call service (40) (cellular network or VoIP services). The term “phone calls” hereinafter and in the claims refers to cellular calls and/or VoIP calls.

The method of recording and/or publishing a call may enable the user to conduct a phone call with a participant by the phone call service (40) that may be an existing VoIP service, cellular networking service or independent built-in VoIP service.

The method may record the phone call by a recording system (50) that may be an existing recording system that may be built-in the internet device of the user or by an independent recording system that may be a part of the method and/or an external program.

The method may send to the participant of said phone call a digital notification for asking permission from the participant to the user to upload the recording of their phone call to the account of the user and/or to allow other users to hear it and/or copy it and/or edit it and/or parts of the sound file.

FIG. 1B is a block diagram of a system for recording and/or disseminating a phone call. For example, a user Internet device 102 (e.g., a cell phone, a smartphone, a portable computing device and/or a fixed computing device) may include a calling program 104 and/or a recording program 106. Optionally the device 102 includes a program 111 for requesting permission to publicize to from a participant in a phone call. For example, the program 111 sends a message 112 (e.g., text, voice, otherwise) to an Internet device 110 of the participant (e.g., a telephone, a cell phone, a smartphone, a portable computing device and/or a fixed computing device).

In some embodiments, the recording program 106 records a recording of the conversation. Some embodiments of the method enable a user to create an account 116 and to upload to a database in his account 116 the recording 107 of his phone call with a participant. Optionally, a notification 112 is sent to a participant (e.g., to his device 110) of the phone call a at the end of that phone call, and/or before the call and/or at another time, requesting his permission to the user to maintain the recording 107 of their phone call and/or to upload it to the user's account 116. Optionally, the user device 102 also receives a message 114 from the user given permission to publicize and/or store the recording 107.

The method may enable the user to upload to his account 116 the recording 107 of the phone call after receiving the permission 114 in a message) from some or all participants of that phone call and/or enables the user to tag and/or index the recording (e.g., by hashtag 108), e.g., to record the permission 114 and/or to tag the recording according to categories and subcategories (e.g., enabling others to search and/or find the recordings according such key words). Some aspects of an embodiment may include ability for the user to tag his phone recordings 107 and/or the recipient of the phone call to tag that phone recording 107 and/or other followers to tag a phone recording 107. Alternatively, or additionally a recipient and/or a follower may suggest a tag to a phone recording 107 and/or a user may optionally accept the suggested tag and/or add it to a database e.g., on his account 116 and/or onto a sharing network 118 (e.g., social media) according to the stipulations of the permission 114.

The recordings 107 in the account 116 may optionally be shared publicly and/or with pre-approved followers, for example via a social network. There may be a function for users to browse other users' recordings by tags. Users may have an option to “like” recordings, and/or follow other users and/or to add their content to a feed, in the same manner as of the Instagram™ social networking service. The method may also enable the user to add recordings as a ‘story’ to a sequential feed, similar to Instagram™ and Snapchat™.

In some embodiments, the method may enable users to follow other users' feeds. The Users may have an option to set their account 116 as “private”, (e.g., in a private list any new follower request may be subject to the user's approval). Users may be able to connect their account 116 to other social networking sites 118, enabling them to share uploaded recordings to those sites 118 and/or platforms.

A person may be able to download the web platform to his internet device, which may include, for example, his or her mobile phone. The person may be able to open an account 116, and upload recordings 107 of his or her phone calls. The account 116 of the user may include many recordings 107 that may be arranged and sorted by subjects and categories.

In the example where the registered user is a patent lawyer, his or her account 116 may include dozens or even hundreds of recordings of phone calls that he or she has conducted with various participants (e.g., clients and/or colleagues) who of course have given their permission 114 for such use. A great deal of knowledge may be accumulated and can serve as a basis for the search of information by the general public. Another example could be a psychologist that conducts phone calls with patients about child care, conversations with a chef about cooking. It also seems that many people will be curious to listen also to recordings 107 of phone calls from other people talking about very personal matters. Each user may have an account, similar to his or her Instagram account. In some embodiments, the account 116 may be without photons but simply with recordings 107 of his or her phone calls.

When a user see that he or she is going to have a phone call that may be worthy to be recorded and uploaded to his or her account, then the user may ask the participant an advanced and/or in the middle of the call and/or after the call consent to record the phone call and/or publish the file for his account. Optionally a phone call may be conducted through a program which is a part of an embodiment of the invention and/or with an external program. An aspect of an embodiment of the invention may be to tag a digital permission 114 to the recording or to store it in the processing device.

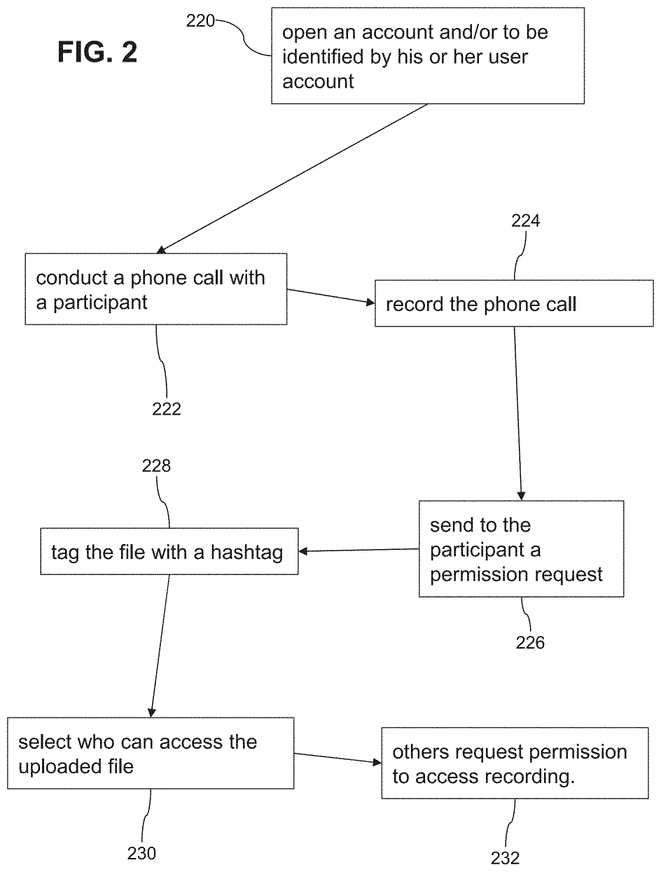

FIG. 2 is a flow chart illustrating an embodiment of the current invention.

In some embodiments, the method for a social networking service for sharing a recording of a phone call is performed by a processing device running on an internet device. The process may include any or all of the following steps and features:

In some embodiments, a user may use the internet device to open 220 an account and/or to be identified by his or her user account.

In some embodiments, a user may conduct 222 a phone call with a participant. For example, the call may be conducted 222 using a phone call service. Optionally the phone call service may include an application running on the interne device. For example, the calling service may include an existing VoIP service, cellular networking service or independent built-in VoIP service.

In some embodiments, the user records 224 the phone call. For example, a recording may be made using a recording system that may include an existing recording system that may be built-in the internet device of the user and/or by an independent recording system that may be a part of the method and/or an external program.

In some embodiments, the participant of the phone call will receive digital notification asking permission from the participant for the user to upload the recording of their phone call to the account of the user and/or to allow other users to hear it and/or copy it and/or edit it and/or parts of the sound file. For example, the user internet device may send 226 the notification automatically, for example, by text messaging, other messaging, over a social media etc. Optionally, the user may need to approve the notification before it is sent 226. Alternatively or additionally, the user may send 226 the notification manually.

In some embodiments, the participant to send 228 permission. For example, the permission may include a digital file. For example, the participant may send 228 the file to the user and/or his internet device and/or a server. The permission may be sent for example, as an email and/or over a social network and/or directly using file sharing and/or in another way. Optionally, the permission may be stored and/or tagged into the recording file. For example, it may be stored on the internet device of the user and/or the server.

In some embodiments, the recording may be tagged. For example, the recording may be tagged by a hashtag. Optionally, tagging may be performed by the user and/or automatically (for example, by the internet device) and/or by the participant and/or by others (for example, a listener who accesses the recording).

In some embodiments, access to the file may be given and/or limited. For example, a user may select 230 who may have access to hear the audio file from the database and/or network and/or who can copy and/or who can edit etc.

In some embodiments, people who want to access the recording may request 232 permissions to access the file. For example, a person (e.g., a member of a social network) may request permission from the user and/or participant before being given access to the recording.

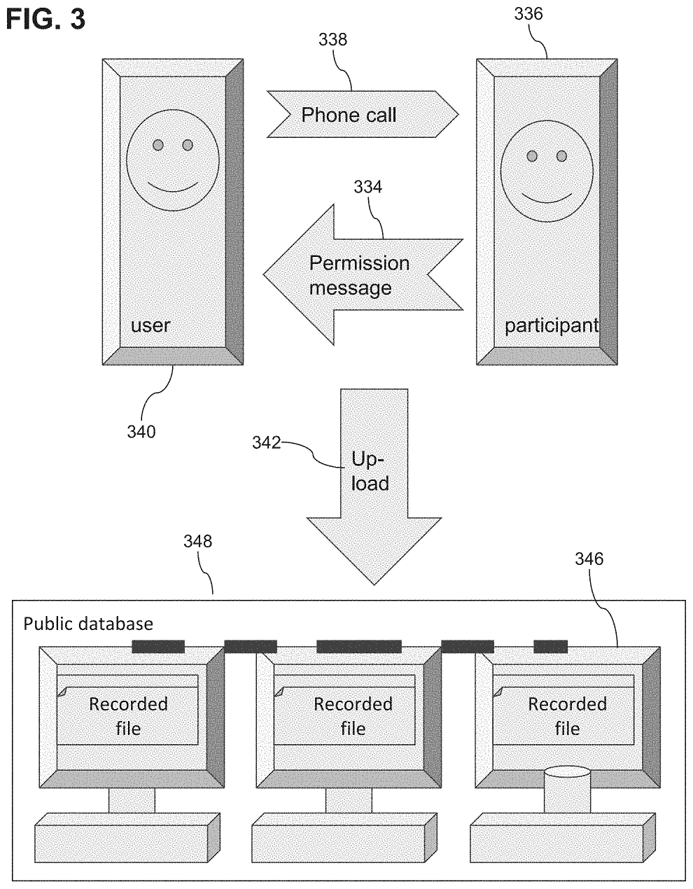

FIG. 3 is a schematic diagram illustrating an embodiment of the current invention. A user 340 may call 338 a participant 336 (and/or add the participant 336 to an existing phone call) and/or request permission to record the phone call. The participant may send back a permission message 334. Optionally, according to the message 334 the phone call may be recorded and/or stored as a recording 346. The recording 346, may be uploaded 342 to a public database 348 and/or shared in accordance with the permission message 334.

Alternatively, or additionally, an embodiment of the current invention may include a function to record and/or store and/or edit and/or publicize video tiles and/or video chats and/or calls

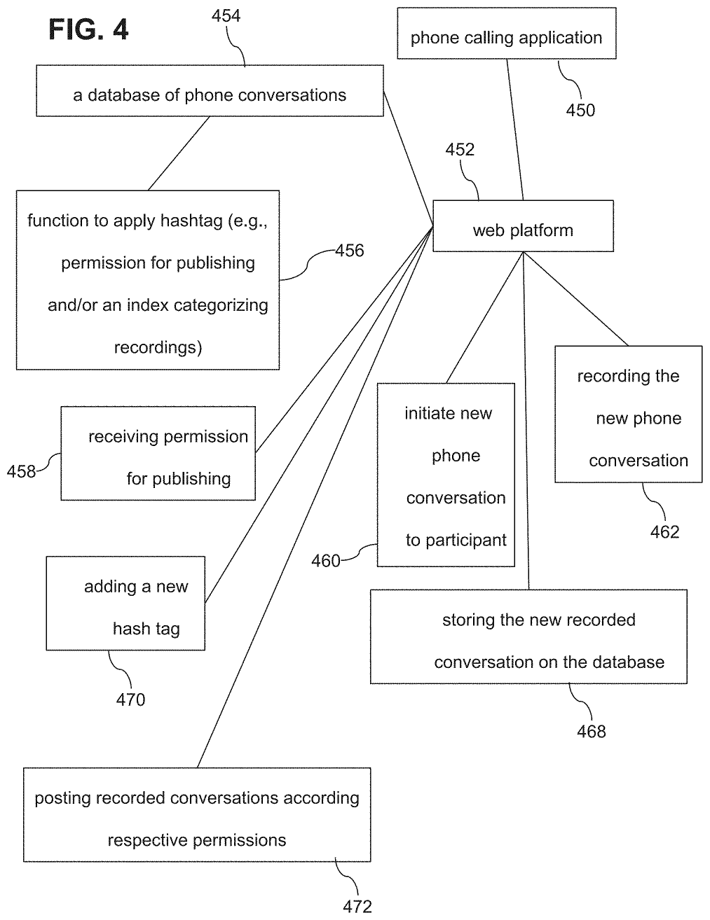

FIG. 4 is a block diagram illustrating an embodiment of the current invention. Some embodiments, may include some or all of the features of illustrated features. Features may be part of a user device (e.g., an interact device) and/or an interact server.

Some phone recording systems may include, a phone calling application 450 and/or a database 454, (e.g., storing a plurality of recordings of phone conversations of a user). Optionally, the system includes a function 456 to apply hashtag defining a respective permission for publishing the recording. For example, each of the recordings may have a separate permission tag and/or value. Alternatively or additionally, the tag may be used to index and/or categorize the recording.

a web platform 452 is optionally integrated into the phone calling system. For example, the platform 452 may control access to and/or editing of the database. For example, the platform 452 may be configured to control initiating 460 a new phone conversation on the phone calling application to a participant; recording 462 the new phone conversation to a new recorded phone conversation; 468 storing the new recorded conversation on the database; receiving 458 a permission for publishing the new recorded conversation e.g., from the participant; adding 470 a new hash tag to an index characterizing the recorded conversation and/or characterizing permission for publicizing the conversation; and/or posting 472 one or more of the recorded conversations. Optionally, posting is according to its respective permission.

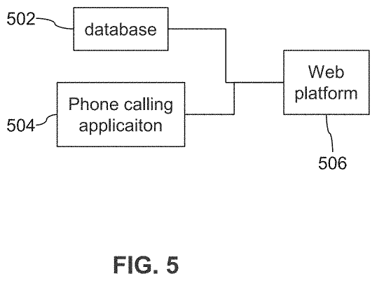

FIG. 5 is a block diagram illustration of a system for publishing phone calls in accordance with an aspect of the current invention. In some embodiments the system is a social network for sharing recordings of phone conversations. For example, a system for sharing recorded phone calls may include a phone calling application 504; a database 502 storing a plurality of recordings of phone conversations associated with a plurality of users, hashtags defining a permission for publishing the recordings and/or an index categorizing the recordings. Optionally, the system also includes a web platform 506 integrating the phone calling application 504 and the database 502. The platform 506 is optionally configured for initiating by a particular user of the plurality of users a new phone conversation on the phone calling application 504 to a participant; recording the new phone conversation to a new recorded conversation; storing the new recorded conversation on the database 502 and associating the new recorded conversation with the particular user; receiving a new permission for publishing the new recorded conversation from the participant; adding a new hash tag to the index characterizing the new recorded conversation; posting each individual recording according to its respective permission and the new recorded conversation according to the new permission.

According to some embodiments of the invention, the database 502 includes a profile of each of the plurality of users and wherein the posting of each individual recording is in accordance with the profile of the owner associated with the individual recording.

According to some embodiments of the invention, the web platform is further configured for posting data from the index about each individual recording in accordance with the respective permission and in accordance with the profile of the owner associated with the individual recording.

According to some embodiments of the invention, the web platform is further configured for sending digital notification requesting the permission from the participant.

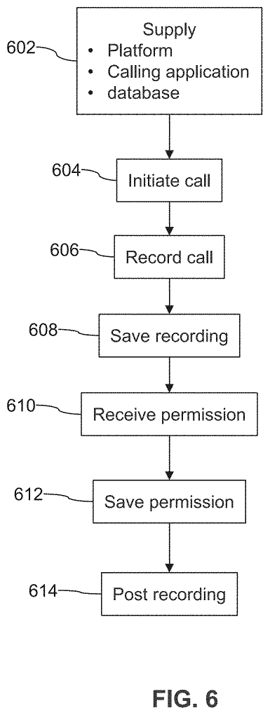

FIG. 6 is a flow chart illustration of a method for publishing phone calls in accordance with an aspect of the current invention. In some embodiments, a phone conversation may be shared over a social network. For example, sharing a recorded phone conversation may include supplying 602 a web platform integrating a phone calling application and a database storing a plurality of recordings of phone conversations each individual recording of the plurality of recordings associated with an owner of a plurality of users, a hashtag defining a respective permission for publishing each individual recording, a profile for each owner and an index categorizing each individual recording.

In some embodiments, a user initiates 604 a phone call to a participant by a with the phone calling application. Optionally, the conversation is recorded 606 by the web platform and/or the recording is saved 608 by the web platform on the database and/or associated to the particular user. In some embodiments, the web platform receives 610 a new permission from the participant for sharing the new recorded conversation. The new permission is optionally saved 612 as a hash tag in the database. The new recording is optionally posted 614 by the web platform of in response to a request from the particular user and/or in accordance with the new permission and/or in accordance with the profile of the particular user. For example, contacts of the particular user stored in his profile may be allowed access to the recording according to the particular user's profile and/or according to the permissions received from the participant. Alternatively or additionally, the recorded phone calls and/or index may be posted 614 openly to all interested. For example, the recordings may be posted 614 over a network (e.g., the Internet and/or a social network).

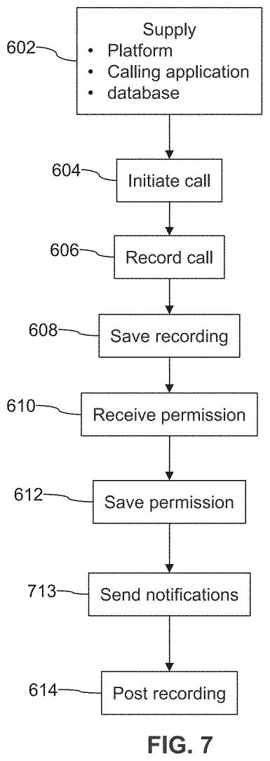

In some embodiments, there may be a set of followers associated with a user (e.g., recorded on his profile). Optionally, a user's recorded phone calls (e.g., calls that he makes, calls in which he participates and/or calls that he saves) are posted 614 to his followers. Alternatively or additionally, when a user records and/or posts a new phone call, a notification may be sent 713 (e.g., see FIG. 7 for example a message may be sent over a network),

According to some embodiments of the invention, the method further includes: receiving 610 the new permission via a message on a social network.

According to some embodiments of the invention, the receiving 610 the new permission is before the phone call.

According to some embodiments of the invention, the receiving the new permission is after the phone call.

According to some embodiments of the invention, the method further includes indexing the new recorded conversation into categories in the database.

According to some embodiments of the invention, the method further includes supplying access to each individual recording associated with each owner in accordance with the profile of the owner.

According to some embodiments of the invention, the method further includes searching the database over a social network.

According to some embodiments of the invention, the method further includes accessing the recorded conversation on a social network.

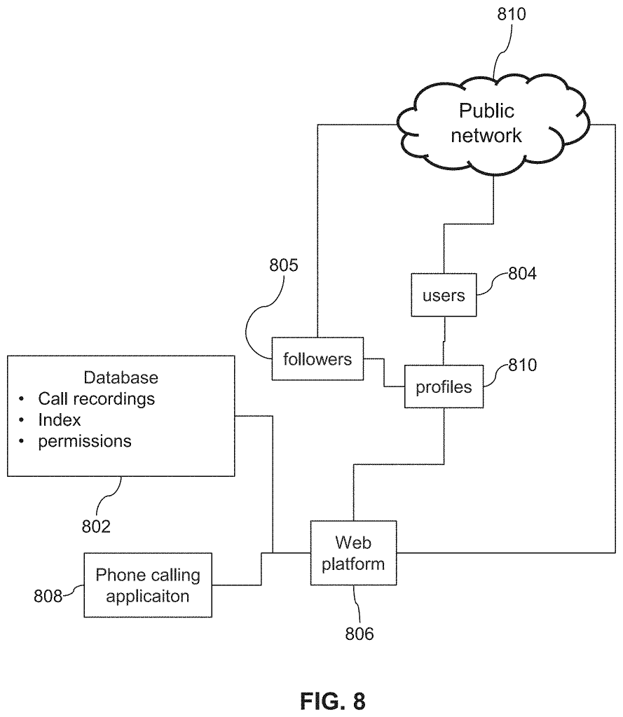

FIG. 8 is a block diagram illustration of a system for publishing phone calls in accordance with an aspect of the current invention. In some embodiments, a web platform 806 manages a social network. For example, the web platform may keep a list of users 804. Optionally, each user is associated with a profile 810 and/or followers 805 associated with each user 804. For example, the followers 805 associated with a user 804 may be listed in the profile 810 of the user 804. For example, a user 804 may use the network platform to communicate with the followers 805. For example, a follower 805 may use the network platform to communicate with a user 804. In some embodiments, the user 804 may user the web server to make phone calls using calling application 808, Additionally or alternatively, the user 804 may use the web platform 806 to save recorded phone calls and/or an index thereof to a database 802. Optionally, the web server 806 posts call recordings of a user to his followers 805. Alternatively or additionally, the web server 806 may send notifications to a user's 804 followers 805 when the user 804 records and/or posts a recorded phone call. In some embodiments, the database 802 and/or profiles 810 and/or calling application 808 and/or list of followers 805 are local to the web platform 806. Alternatively or additionally, the database 802 and/or profiles 810 and/or calling application 808 and/or list of followers 805 may be connected to the web platform 806 over a public network 810. Optionally, communication between the web platform 806 and/or users 804 and/or followers 805 may be over a direct link. Alternatively or additionally, communication between the web platform 806 and/or users 804 and/or followers 805 may be over a public network 810.

It is expected that during the life of a patent maturing from this application many relevant technologies will be developed and the scope of the terms is intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed:

1. A system for a social networking web platform for sharing recorded phone calls of a plurality of users, comprising:
a plurality of profiles; wherein each of said plurality of profiles is associated with a respective user of said plurality of users and includes a plurality of followers respectively associated with a profile of the respective user;
a plurality of phone call recordings respectively associated with the profile of each respective user of said plurality of users, said plurality of phone calls recordings of a phone call conducted by said respective user;
an index categorizing said plurality of phone call recordings;
a phone calling application,
a database storing the plurality of phone call recordings, and said index;
a web platform integrating the phone calling application and the database configured for:
publishing said database for browsing over a public network,
initiating by a particular user of said plurality of users a new phone call on the phone calling application with a participant;
recording the new phone call to a new phone call recording;
storing the new phone call recording on the database and, associating the new said particular user,
receiving a new permission from the participant for publishing the new phone call recording,
adding to said index characterizing the new phone call recordings;
sending a notification of said new phone call to follower associated with the profile said particular user.

2. The system of claim 1, wherein said publishing of each said plurality phone call recordings associated with a particular user is in accordance with the profile of the particular user.

3. The system of claim 1, wherein said publishing of each said plurality phone call recording is in accordance with a permission of user associated with the phone call recording.

4. The system of claim 1, wherein said web platform is further configured for sending digital notification requesting the permission from the participant.

5. A system for a social networking web platform for sharing recorded phone calls of a plurality of users, comprising:
a plurality of profiles; wherein each of said plurality of profiles is associated with a respective user of said plurality of users;
a plurality of followers respectively associated with a profile of each of said plurality Of users;
a plurality of phone call recordings respectively associated with each respective user of said plurality of users, each of said plurality of phone calls conducted by the respective user;
an index categorizing said plurality of phone call recordings;
a phone calling application,
a database storing the plurality of phone call recordings, and said index;
web platform integrating the phone calling application and the database configured for:
posting each recording of said plurality of phone call recordings to the followers of the user associated with the recording,
initiating by a particular user of said plurality of users a new phone call on the phone calling application with a participant;
recording the new phone call to a new phone call recording;
storing the new phone call recording on the database and, associating the new said particular user,
receiving a new permission from the participant; for publishing the new phone call recording,
adding to said index characterizing the new phone call recordings.

6. The system of claim 5, wherein said web platform is further configured for posting the index.

7. The system of claim 3, wherein said web platform is further configured for sending digital notification requesting the permission from the participant.

8. The system of claim 7, wherein said web platform is further configured for sending said digital notification via a message on a social network.

9. The system of claim 7, wherein said web platform is further configured for sending said digital notification before said new phone call.

10. The system of claim 7, wherein said web platform is further configured for sending said digital notification after said new phone call.

11. The system of claim 5, wherein said phone call recordings are shared with other users on a social network.
